(19) United States
(12) Patent Application Publication
(10) Pub. No.: US 2012/0204559 A1
(43) Pub. Date: Aug. 16, 2012

(54) SUPERCHARGING SYSTEM FOR INTERNAL COMBUSTION ENGINE

(75) Inventors: Keiji Yoeda, Numazu-shi (JP); Kichiro Kato, Suntou-gun (JP); Fumio Takamiya, Gotenba-shi (JP); Satoshi Sugiyama, Mishima-shi (JP); Naruto Yamane, Susono-shi (JP); Hiroyuki Suganuma, Susono-shi (JP)

(73) Assignee: TOYOTA JIDOSHA KABUSHIKI KAISHA, Toyota-shi (JP)

(21) Appl. No.: 13/503,824

(22) PCT Filed: Oct. 30, 2009
(86) PCT No.: PCT/JP2009/068690

§ 371 Date: Apr. 24, 2012

(30) Foreign Application Priority Data
Jul. 6, 2010 (JP) 30/10/2009

(51) Int. Cl. F02B 33/32; F02M 25/07

(52) U.S. Cl. 60/605.2

(57) ABSTRACT

A supercharging system comprising a pressure wave supercharger which supercharges an internal combustion engine by increasing a pressure of gas in a cell using a pressure wave of exhaust gas and discharging from an intake gas outlet port to an intake gas passage the gas pressurized further comprises a first motor which rotates a rotor, and a valve plate and a second motor capable of changing a position of the intake gas outlet port with respect to an exhaust gas inlet port. The motors are controlled so as to change a rotation number of the rotor and the position of the intake gas outlet port with respect to the exhaust gas inlet port based on a quantity of flow of exhaust gas to be recirculated to the intake gas passage.

### TECHNICAL FIELD

The present invention relates to a supercharging system for an internal combustion engine including a pressure wave supercharger which performs supercharging by leading air and exhaust gas alternately into plural cells provided in a case and increasing a pressure of the air in the cells using a pressure wave of the exhaust gas led into the cells.

### BACKGROUND ART

There is known a pressure wave supercharger which is provided so as to connect between an intake gas passage and an exhaust gas passage and performs supercharging using a pressure wave of exhaust gas. In the pressure wave supercharger, air and exhaust gas are led into plural cells provided in a case alternately, and a pressure of the air in the cells is increased by using a pressure wave of the exhaust gas led into the cells. Then, the pressure wave supercharger performs supercharging by discharging the pressurized air to the intake gas passage. In an internal combustion engine provided with the pressure wave supercharger, it is possible to recirculate a part of the exhaust gas from the exhaust gas passage to the intake gas passage via the inside of the pressure wave supercharger. For example, there is known an exhaust gas recirculation system which has a valve provided on the intake gas passage upstream of the pressure wave supercharger and leads the exhaust gas in the cells to the intake gas passage by closing the valve when the recirculation of the exhaust gas is performed (see patent literature 1). In addition, there are Patent Literatures 2 and 3 as prior art references in relation to the present invention.

### CITATION LIST

### Patent Literature

Patent Literature 1: JP-U-58-108256

Patent Literature 2: JP-A-04-019327

Patent Literature 3: JP-A-2008-280975

### SUMMARY OF INVENTION

### Technical Problem

In the system of the Patent Literature 1, a quantity of the exhaust gas (hereinafter, also referred to as EGR gas) which is recirculated from the exhaust gas passage to the intake gas passage via the pressure wave supercharger is adjusted by changing an opening of the valve provided on the intake gas passage. However, the quantity of gas discharged from the cell to the intake gas passage depends on the time during which the cell is connected to an intake gas outlet port. The connection time depends on a rotation number of a rotor. In the system of the Patent Literature 1, the rotation number of the rotor depends on a rotation number of the internal combustion engine. Thereby, there is a possibility that a target quantity of EGR gas cannot be recirculated. Further, in the system of the Patent Literature 1, since a position of the intake gas outlet port is fixed with reference to an exhaust gas inlet port, the time when the cell connects with the intake gas outlet port depends on the rotation number of the rotor. In this case, when the rotation number of the internal combustion engine changes and the rotation number of the rotor changes, there is a possibility that a sufficiently pressurized gas cannot be discharged to the intake gas passage. Thereby, there is a possibility that a pressure of intake gas cannot be increased until a target intake pressure.

In view of the foregoing, one object of the present invention is to provide a supercharging system for an internal combustion engine capable of recirculating a target quantity of exhaust gas to an intake gas passage via a pressure wave supercharger without decreasing a supercharging pressure.

### Solution to Problem

A supercharging system for an internal combustion engine of the present invention comprises a pressure wave supercharger that includes a rotor which is arranged in a case rotatably around an axis line, plural cells which are provided in the case so as to penetrate from one end to the other end in a direction of the axis line of the case and rotate with the rotor, an intake gas outlet portion which is provided on the one end of the case and is connected with an intake gas passage of an internal combustion engine, an intake gas inlet portion which is provided on the one end of the case, an exhaust gas inlet portion which is provided on the other end of the case and is connected with an exhaust gas passage of the internal combustion engine, and an exhaust gas outlet portion which is provided on the other end of the case, and that performs supercharging of the internal combustion engine by increasing a pressure of gas in each of the cells using a pressure wave of exhaust gas led into the cell from the exhaust gas inlet portion and discharging from the intake gas outlet portion to the intake gas passage the gas pressurized, wherein the supercharging system comprises: a rotation number change device capable of changing the rotation number of the rotor, a phase change mechanism capable of changing a position of the intake gas outlet portion with respect to the exhaust gas inlet portion by rotating at least either one of the exhaust gas inlet portion and the intake gas outlet portion around the axis line, a target EGR quantity setting device which sets a target EGR quantity as a quantity of flow of exhaust gas to be recirculated from the exhaust gas passage to the intake gas passage based on an operation state of the internal combustion engine, a control device which controls based on the target EGR quantity the rotation number change device and the phase change mechanism so as to change the rotation number of the rotor and the position of the intake gas outlet portion with respect to the exhaust gas inlet portion respectively.

According to the supercharging system of the present invention, since it is possible to change the rotation number of the rotor, it is possible to adjust a time to connect the cell with the intake gas outlet portion. Thereby, it is possible to recirculate the target EGR quantity of exhaust gas to the intake gas passage via the pressure wave supercharger. Furthermore, in the supercharging system of the preset invention, it is possible to change the position of the intake gas outlet portion with respect to the exhaust gas inlet portion. Thereby, even though the rotation number of the rotor is changed, it is possible to adjust the position of the intake gas outlet portion with respect to the exhaust gas inlet portion so that the cell is connected with the intake gas outlet portion when the pressure wave reaches an intake gas end of the cell. Accordingly, it is possible to suppress decreasing of a supercharging pressure due to an insufficient pressurization of air in the cell.

In one embodiment of the supercharging system of the present invention, the control device may control the rotation number change device and the phase change mechanism so that the rotation number of the rotor decreases while the intake gas outlet portion approaches the exhaust gas inlet portion, as the target EGR quantity increases. A quantity of flow of the EGR gas may be increased by increasing the time to connect the cell with the intake gas outlet portion. Thereby, by decreasing the rotation number of the rotor, it is possible to increase the quantity of the EGR gas. When the rotation number of the rotor is decreased in this manner, an angle at which the rotor rotates until the pressure wave reaches the intake gas end of the cell decreases. To solve this problem, the intake gas outlet portion is approximated to the exhaust gas inlet portion. As a result, it is possible to adjust the position of the intake gas outlet portion with respect to the exhaust gas inlet portion so that the cell is connected with the intake gas outlet portion when the pressure wave reaches the intake gas end of the cell. Thereby, it is possible to recirculate the target EGR quantity of exhaust gas to the intake gas passage without decreasing the supercharging pressure.

In one embodiment of the supercharging system of the present invention, the control device may control the rotation number change device and the phase change mechanism so that the pressure wave of the exhaust gas led into the cell from the exhaust gas inlet portion reaches an intake gas inlet portion side end of the cell when the rotor rotates and the cell connects with the intake gas outlet portion. In this case, it is possible to prevent decreasing of the supercharging pressure reliably.

In one embodiment of the supercharging system of the present invention, an electric motor which rotates the rotor may be provided as the rotation number change device. In this case, it is possible to change the rotation number of the rotor easily.

### BRIEF DESCRIPTION OF DRAWINGS

FIG. 1 schematically shows a main portion of an internal combustion engine in which a supercharging system according to one embodiment of the present invention is incorporated.

FIG. 2 shows an enlarged view of the pressure wave supercharger in FIG. 1.

FIG. 3 shows an intake side end of the pressure wave supercharger viewed from the arrow III in FIG. 2.

FIG. 4 shows an exhaust side end of the pressure wave supercharger viewed from the arrow IV in FIG. 2.

FIG. 5 shows a valve plate of the pressure wave supercharger viewed from the arrow V in FIG. 2.

FIG. 6 shows a functional block diagram of a control system of the pressure wave supercharger.

FIG. 7 shows the inside of the pressure wave supercharger developed along a rotation direction of the rotor when the pressure wave supercharger is operated so as to discharge only air from the cell to a downstream section.

FIG. 8 shows the inside of the pressure wave supercharger developed along the rotation direction of the rotor when the pressure wave supercharger is operated so as to discharge both exhaust gas and air from the cell to the downstream section.

FIG. 9 shows the inside of the pressure wave supercharger developed along the rotation direction of the rotor when the state shown in FIG. 7 is changed to a state of decreasing only a rotation speed of the rotor.

FIG. 10 shows an example of a relation between a target EGR rate and a target rotation number.

FIG. 11 shows an example of a relation between the target rotation number and a phase angle.

### DESCRIPTION OF EMBODIMENTS

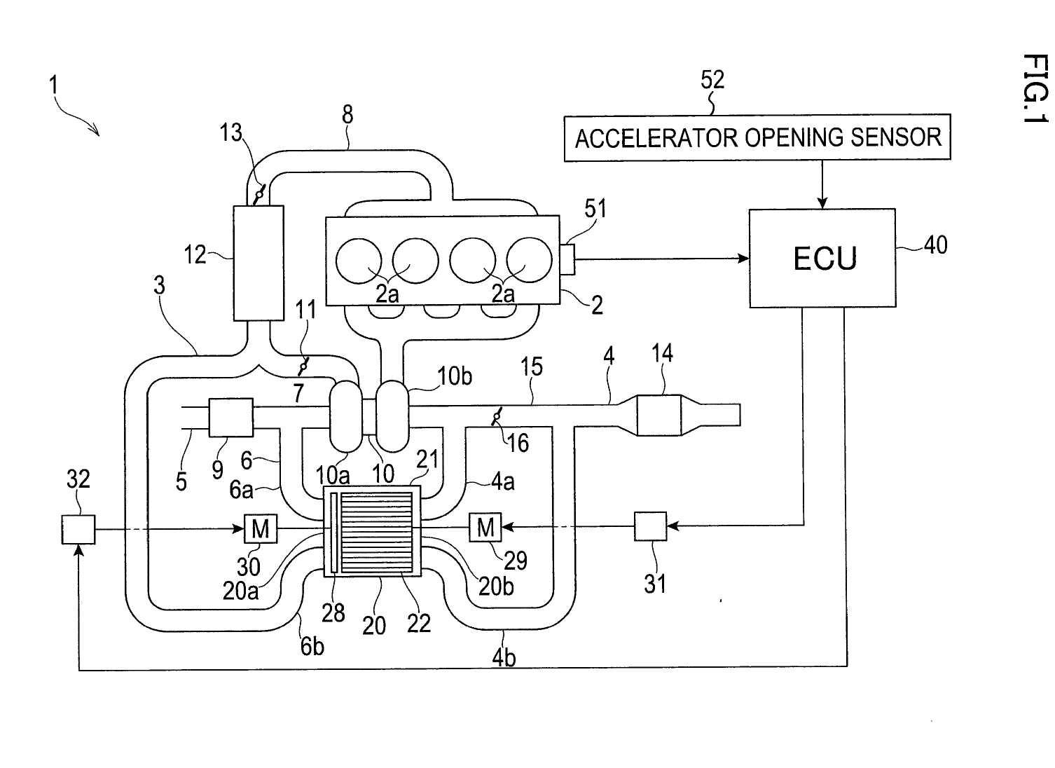

FIG. 1 schematically shows a main portion of an internal combustion engine in which a supercharging system according to one embodiment of the present invention is incorporated. The internal combustion engine (hereinafter, referred to as an engine) 1 is a diesel engine mounted on a vehicle as a traveling power source and includes an engine main body 2 having plural cylinders 2a (four cylinders in FIG. 1). An intake gas passage 3 and an exhaust gas passage 4 are connected to each of the cylinders 2a.

The intake gas passage 3 includes a common passage 5, a first branch passage 6, a second branch passage 7, and a merging passage 8. The first branch passage 6 and the second branch passage 7 are diverged from the common passage 5. The first branch passage 6 and the second branch passage 7 are merged to the merging passage 8. The common passage 5 is provided with an air cleaner 9 which filters intake gas. The first branch passage 6 is provided with an intake side end 20a of a pressure wave supercharger 20. The second branch passage 7 is provided with a compressor 10a of a turbocharger 10 and a first control valve 11 capable of opening and closing the second branch passage 7. The merging passage 8 is provided with an intercooler 12 for cooling intake gas and a second control valve 13 capable of opening and closing the merging passage 8.

The exhaust gas passage 4 is provided with a turbine 10b of the turbocharger 10, an exhaust side end 20b of the pressure wave supercharger 20, and a catalyst 14 for exhaust gas cleaning in order from the upstream of an exhaust gas flow direction. The exhaust gas passage 4 is provided with a bypass passage 15 which leads exhaust gas to the catalyst 14 bypassing the pressure wave supercharger 20 and a bypass valve 16 capable of opening and closing the bypass passage 15.

The turbocharger 10 and the pressure wave supercharger 20 will be described. The turbocharger 10 is a well known turbocharger. The turbocharger 10 rotates the compressor 10a by rotating the turbine 10b provided in the exhaust passage 4 using exhaust gas, and thereby performs supercharging. The pressure wave supercharger 20 is a supercharger which increases a pressure of intake gas led into an inside from the intake side end 20a by using a pressure wave of exhaust gas led into the inside from the exhaust side end 20b and thereby performs supercharging.

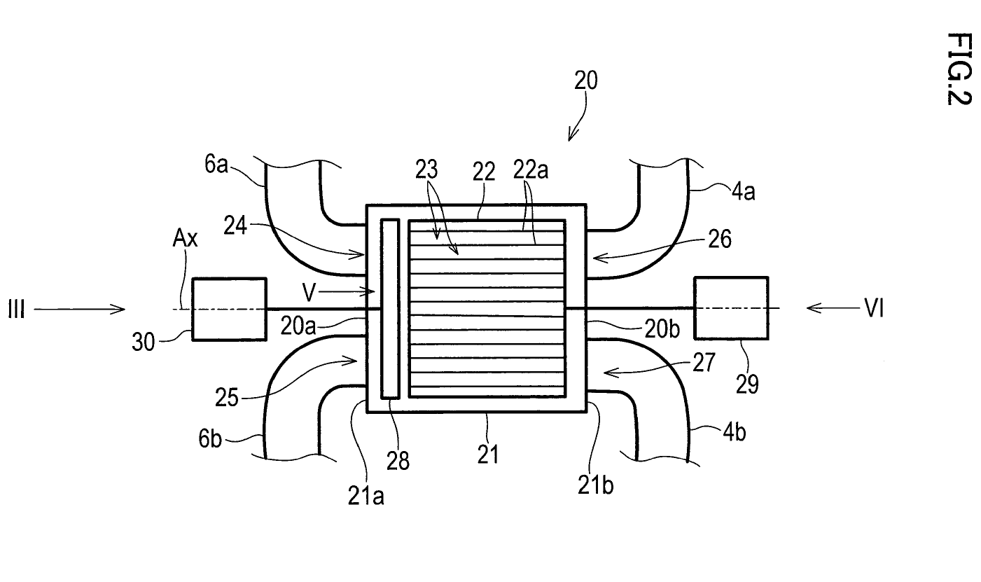

As shown in an enlarged view in FIG. 2, the pressure wave supercharger 20 includes a cylindrical case 21 that is connected to the intake gas passage 3 at the intake side end 20a and is connected to the exhaust gas passage 4 at the exhaust side end 20b. A rotor 22 is provided in the case 21. The rotor 22 is supported by the case 21 so as to be rotatable around an axis line Ax. In FIG. 2, a gap between the case 21 and the rotor 22 is enlarged in order to facilitate understanding. Actually, the gap is negligible. The rotor 22 is provided with plural partition walls 22a located in the direction of the axis line Ax from one end of the rotor 22 to the other end of the rotor 22. The inside of the case 21 is divided into plural cells 23 penetrating in the direction of the axis line Ax by the partition walls 22a.

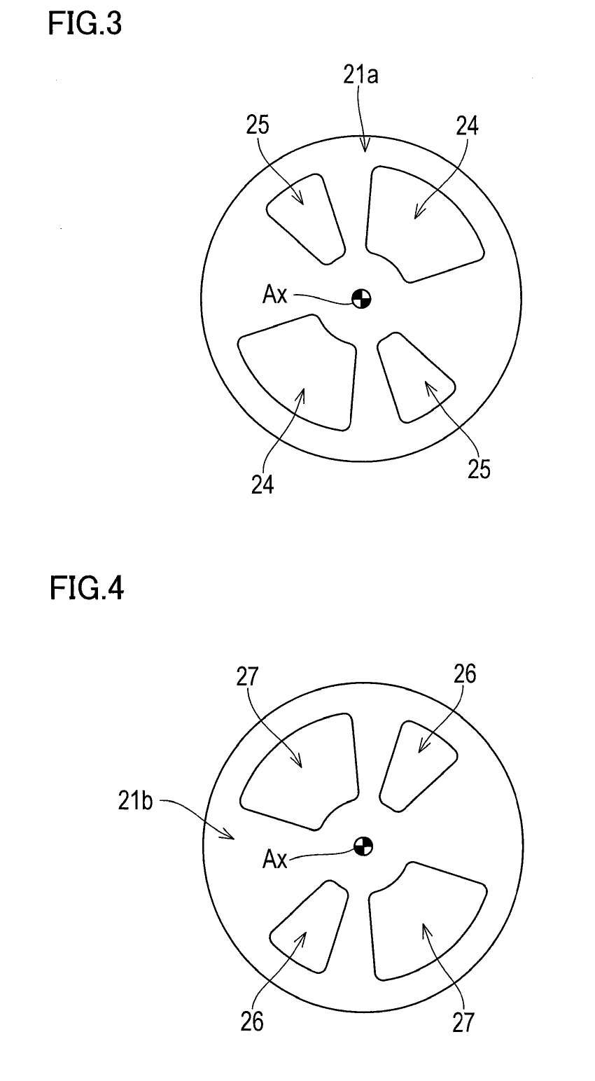

FIG. 3 shows an intake side end 21a of the case 21 viewed from the arrow III in FIG. 2. As shown in this figure, the intake side end 21a is provided with two intake gas inlet ports 24 and two intake gas outlet ports 25. As shown in this figure, the intake gas inlet port 24 and the intake gas outlet port 25 are arranged alternately in a circumferential direction on one end face of the case 21. The two intake gas inlet ports 24 are arranged symmetrically across the axis line Ax. Similarly, the two intake gas outlet ports 25 are also arranged symmetrically across the axis line Ax. A portion 6a of the first branch passage 6 on the upstream side of the direction of the intake gas flow than the pressure wave supercharger 20 is connected to each intake gas inlet port 24. Hereinafter, the portion 6a of the first branch passage 6 is referred to as an upstream section. On the other hand, a portion 6b of the first branch passage 6 on the downstream side of the direction of the intake gas flow than the pressure wave supercharger 20 is connected to each intake gas outlet port 25. Hereinafter, the portion 6b of the first branch passage 6 is referred to as a downstream section.

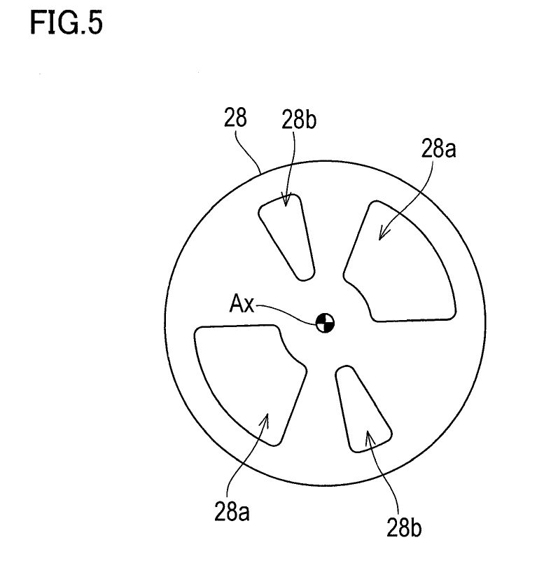

FIG. 4 shows an exhaust side end 21b of the case 21 viewed from the arrow IV in FIG. 2. As shown in this figure, the exhaust side end 21b is provided with two exhaust gas inlet ports 26 as an exhaust gas inlet portion and two exhaust gas outlet ports 27 as an exhaust gas outlet portion. As shown in this figure, the exhaust gas inlet port 26 and the exhaust gas outlet port 27 are arranged alternately in a circumferential direction. As shown in this figure, the two exhaust gas inlet ports 26 are arranged symmetrically across the axis line Ax. Similarly, the two exhaust gas outlet ports 27 are also arranged symmetrically across the axis line Ax. The exhaust gas inlet port 26 is positioned so as to be connectible with the intake gas outlet port 25 via the cell 23. The exhaust gas outlet port 27 is positioned so as to be connectible with the intake gas inlet port 24 via the cell 23. A section 4a of the exhaust passage 4 on the upstream side of the direction of the exhaust gas flow than the pressure wave supercharger 20 is connected to each exhaust gas inlet port 26. On the other hand, a section 4b of the exhaust passage 4 on the downstream side of the direction of the exhaust gas flow than the pressure wave supercharger 20 is connected to each exhaust gas outlet port 27.

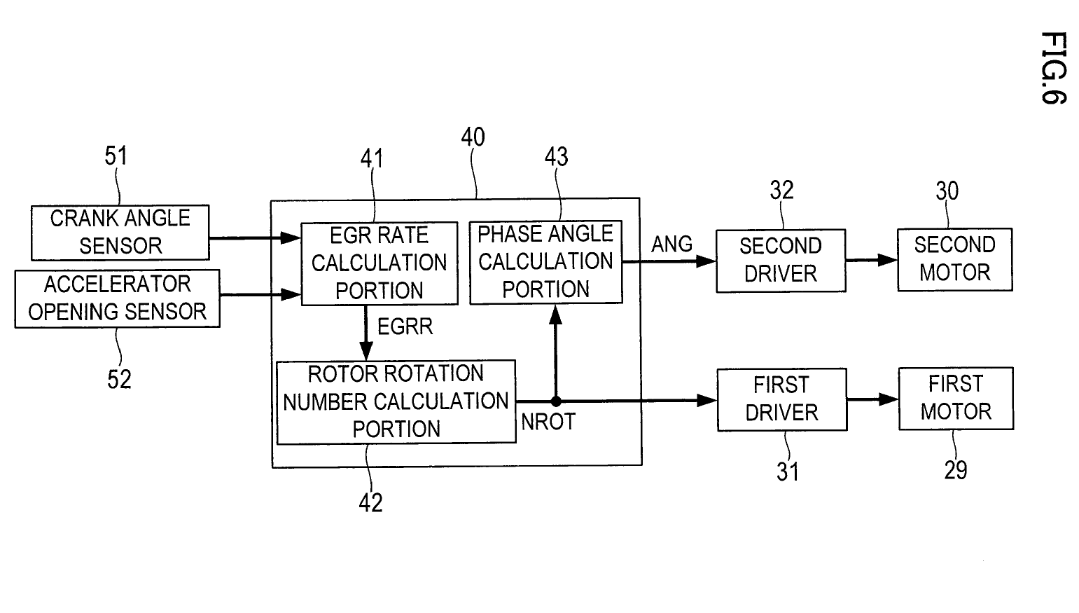

As shown in FIG. 2, a valve plate 28 is provided in the case 21. As shown in this figure, the valve plate 28 is arranged so as to be sandwiched between the intake side end 21a of the case 21 and the rotor 22. In FIG. 2, a gap between the valve plate 28 and the case 21 is enlarged in order to facilitate understanding. Moreover, a gap between the valve plate 28 and the rotor 22 is enlarged in order to facilitate understanding. Actually, these gaps are negligible. The valve plate 28 is supported by the case 21 so as to be rotatable around the axis line Ax. FIG. 5 shows the valve plate 28 viewed from the arrow V in FIG. 2. As shown in this figure, the valve plate 28 is provided with two intake gas inlet ports 28a and two intake gas outlet ports 28b similarly to the intake side end 21a of the case 21. The intake gas inlet port 28a and the intake gas outlet port 28b are arranged in a circumferential direction alternately. The two intake gas inlet ports 28a are arranged symmetrically across the axis line Ax. The two intake gas outlet ports 28b are arranged symmetrically across the axis line Ax. The valve plate 28 is arranged in the case 21 so that the intake gas inlet port 28a overlaps with the intake gas inlet port 24 of the case 21 and the intake gas outlet port 28b overlaps with the intake gas outlet port 25 of the case 21. A length in the circumferential direction of the intake gas inlet port 28a of the valve plate 28 is shorter than a length in the circumferential direction of the intake gas inlet port 24 of the case 21. Similarly, a length in the circumferential direction of the intake gas outlet port 28b of the valve plate 28 is shorter than a length in the circumferential direction of the intake gas outlet port 25 of the case 21. Thereby, even though the valve plate 28 rotates, if rotation angle is within a prescribed angle, the intake gas inlet port 24 and the intake gas inlet port 28a remain overlapped with each other. In this case, the intake gas outlet port 25 and the intake gas outlet port 28b also remain overlapped with each other. In the pressure wave supercharger 20, gas is led into the cell 23 via the intake gas inlet port 24 of the case 21 and the intake gas inlet port 28a of the valve plate 28. Thereby, the intake gas inlet port 24 and the intake gas inlet port 28a correspond to an intake gas inlet portion of the present invention. Gas in the cell 23 is discharged via the intake gas outlet port 25 of the case 21 and the intake gas outlet port 28b of the valve plate 28. Thereby, the intake gas outlet port 25 and the intake gas outlet port 28b correspond to an intake gas outlet portion of the present invention.

As shown in FIG. 2, the pressure wave supercharger 20 includes a first motor 29 for rotating the rotor 22 as a rotation number change device and a second motor 30 for adjusting a position of the valve plate 28 with respect to the intake side end 21a of the case 21. The first motor 29 is a publicly known electric motor. The first motor 29 rotates the rotor 22 in a predetermined direction so that the cells 23 are connected to the intake gas inlet port 28a, the exhaust gas inlet port 26, the intake gas outlet port 28b, and the exhaust gas outlet port 27 in order. The second motor 30 can rotate the valve plate 28 clockwise and counterclockwise. The second motor 30 rotates the valve plate 28 to change positions of the intake gas outlet port 28b with respect to the exhaust gas inlet port 26. A publicly known stepping motor is used as the second motor 30, for example. By changing the positions of the intake gas outlet port 28b with respect to the exhaust gas inlet port 26 in this manner, the valve plate 28 and the second motor 30 correspond to a phase change mechanism of the present invention.

FIG. 6 is a functional block diagram of a control system of the pressure wave supercharger 20. As shown in this figure, an engine control unit (ECU) 40 as a control device controls the first motor 29 and the second motor 30. The ECU 40 is configured as a computer which controls operation states of the engine 1. Although it is not shown, the ECU 40 includes a microprocessor and peripheral devices, such as a RAM and a ROM, which are necessary for the operation of the microprocessor. As shown in this figure, the ECU 40 controls the first motor 29 via a first driver 31 and controls the second motor 30 via a second driver 32. A crank angle sensor 51 and an accelerator opening sensor 52 are connected with the ECU 40. The crank angle sensor 51 outputs a signal corresponding to an engine rotation speed (rotation number) of the engine 1. The accelerator opening sensor 52 outputs a signal corresponding to an accelerator opening. In addition to the above sensors, various sensors are further connected with the ECU 40, but they are omitted in the figure.

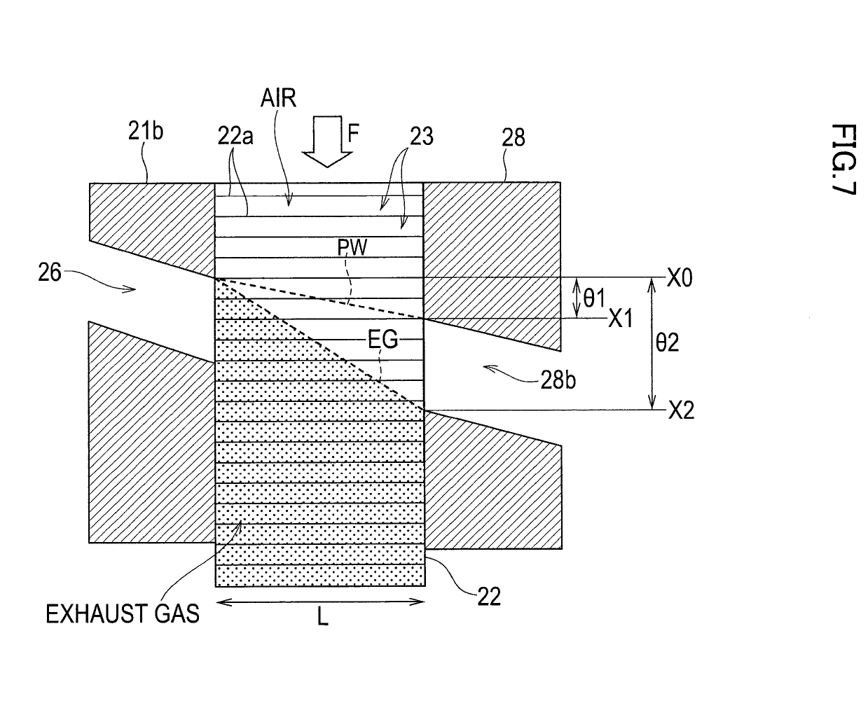

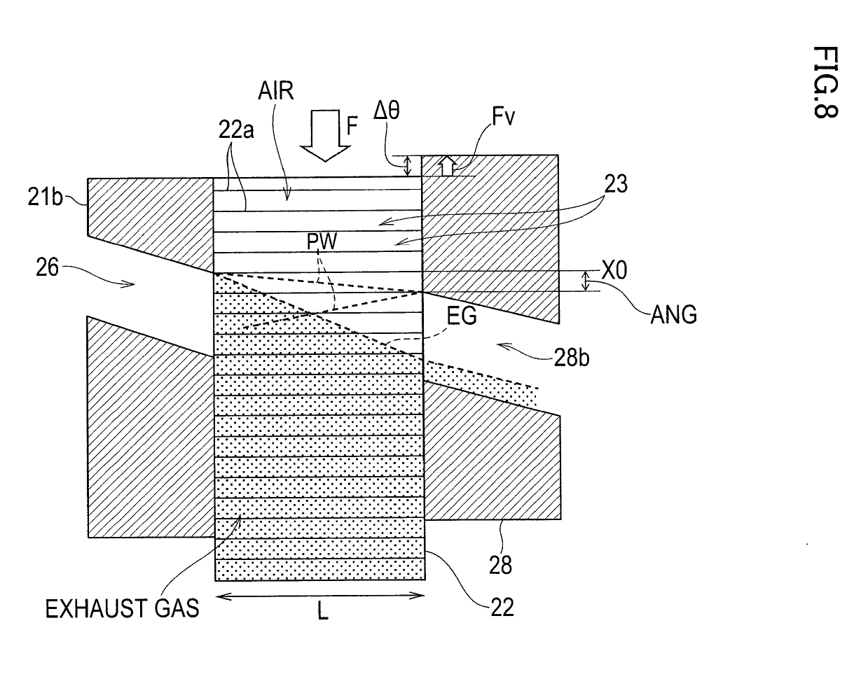

The ECU 40 controls the first motor 29 and the second motor 30 so that the appropriate quantity of exhaust gas is recirculated to the intake gas passage 3 in accordance with operation states of the engine 1 and the supercharging pressure reaches a target supercharging pressure. The control method will be described with reference to FIGS. 7 and 8.

FIG. 7 shows the inside of the pressure wave supercharger 20 developed along a rotation direction of the rotor 22 when the pressure wave supercharger 20 is operated so as to discharge only air from the cell 23 to the downstream section 6b. That is, FIG. 7 shows the pressure wave supercharger 20 which is operated so as to zero the quantity of EGR gas. This operation mode may be hereinafter also referred to as normal mode. Each cell 23 moves from the top to the bottom in this figure as indicated by the arrow F. Air is charged in the cell 23 shown at the top of this figure. In this state, the exhaust gas and its pressure wave are led into the cell 23 when the exhaust gas end of the cell 23 is connected to the exhaust gas inlet port 26. The exhaust gas and the pressure wave travel in the cell 23 from the exhaust gas end to the intake end. In this figure, a broken line PW shows the pressure wave movement and a broken line EG shows the movement of a boundary between the exhaust gas and the air. As shown with these broken lines, the traveling speed of the pressure wave is higher than the traveling speed of the boundary. As shown in this figure, in the normal mode, the cell 23 connects with the intake gas outlet port 28b when the pressure wave reaches the intake gas end of the cell 23. Since the pressure wave presses the air in the cell 23 toward the intake gas side while traveling to the intake gas side, the air in the cell 23 is most pressurized when the pressure wave reaches the intake gas end. Thereby, by connecting the cell 23 with the intake gas outlet port 28a at this time, it is possible to supply the most pressurized air to the downstream section 6b.

Thereafter, as shown in this figure, in the normal mode, the cell 23 is disconnected from the intake gas outlet port 28b when the boundary reaches the intake gas end of the cell 23. Thereby, it is possible to prevent the inflow of the exhaust gas to the intake gas passage 3. Although it is not shown, the cell 23 thereafter is connected to the exhaust gas outlet port 27. The exhaust gas in the cell 23 is discharged to the exhaust gas passage 4 at this time. Then, the cell 23 is connected to the intake gas inlet port 28a. Thereby, the intake gas is charged in the cell 23. After this, by these operations are repeated, the engine 1 is supercharged. As described above, in the normal mode, the rotor 22 and the valve plate 28 are controlled to connect and disconnect the cell 23 as follows. The cell 23 is connected to the intake gas outlet port 28b when the pressure wave reaches the intake gas end of the cell 23. Further, the cell 23 is disconnected from the intake gas outlet port 28b when the boundary between the exhaust gas and the intake gas reaches the intake gas end of the cell 23. In the normal mode, the rotation number of the first motor 29 may be set in accordance with the rotation number of the engine 1 similarly to a publicly known pressure wave superchargers.

In the normal mode, as described above, the pressure wave supercharger 20 is operated so that the cell 23 is connected to the intake gas outlet port 28b when the pressure wave reaches the intake gas end of the cell 23. It is assumed that the pressure wave propagation speed is u, and the length of the cell 23 is L. In this case, the time needed to travel the pressure wave from the exhaust gas end to the intake gas end is expressed in L/u. The cell 23 is moving in the direction of the arrow F in FIG. 7 while the pressure wave travels. It is assumed that the moving speed of the cell 23, that is, the rotation speed of the rotor 22 is w. In this case, the position where the pressure wave reaches the intake gas end corresponds to a position advancing by w×(L/u) in the rotation direction of the rotor 22 from a position (hereinafter also referred to as reference position) X0 where the cell 23 connects with the exhaust gas inlet port 26. Consequently, a distance θ1 between the reference position X0 and an open position X1 where the cell 23 connects with the intake gas outlet port 28b may be set according to the following equation (1).

θ1=w(L/u) (1)

In the normal mode, the cell 23 is disconnected from the intake gas outlet port 28b when the boundary between the exhaust gas and the air reaches the intake gas end of the cell 23. It is assumed that the traveling speed of the boundary between the exhaust gas and the air is v. In this case, the time needed to travel the boundary from the exhaust gas end to the intake gas end is expressed in L/v. Consequently, a distance θ2 between the reference position X0 and a closed position X2 where the cell 23 is disconnected from the intake gas outlet port 28b may be set according to the following equation (2).

θ2=w(L/v) (2)

A circumferential length (θ2−θ1) of the intake gas outlet port 28a in order to operate the pressure wave supercharger 20 as described above is expressed as the following equation (3).

θ2−θ1=w(L/u−L/v) (3)

As is obvious from the equation (3), the circumferential length of the intake gas outlet port 28b depends on the moving speed w of the cell 23. That is, the circumferential length of the intake gas outlet port 28b is set so as to appropriately operate the pressure wave supercharger 20 in the normal mode when the rotor 22 rotates at a predetermined rotation number. Thereby, when the rotation number of the rotor 22 is lower than the predetermined rotation number, the time to connect the cell 23 with the intake gas outlet port 28b is increased. Accordingly, the exhaust gas is discharged from the cell 23 to the intake gas outlet port 28b.

FIG. 8 shows the inside of the pressure wave supercharger 20 developed along the rotation direction of the rotor 22 when the pressure wave supercharger 20 is operated so as to discharge both the exhaust gas and the air from the cell 23 to the downstream section 6b. That is, FIG. 8 shows the pressure wave supercharger 20 while the exhaust gas is recirculated. This operation mode may be hereinafter also referred to as EGR mode. In this figure, the same components as those in FIG. 7 are denoted by the same reference numeral, and descriptions thereof will be omitted. As shown with the broken line EG in this figure, in the EGR mode, the rotation speed of the rotor 22 is decreased so that the boundary between the exhaust gas and the air reaches the intake gas end of the cell 23 before the intake gas end of the cell 23 is disconnected from the intake gas outlet port 28b. Furthermore, in the EGR mode, the position of the valve plate 28 is adjusted so that the cell 23 is connected with the intake gas outlet port 28b even though the rotation speed of the rotor 22 is decreased in this manner when the pressure wave reaches the intake gas end of the cell 23.

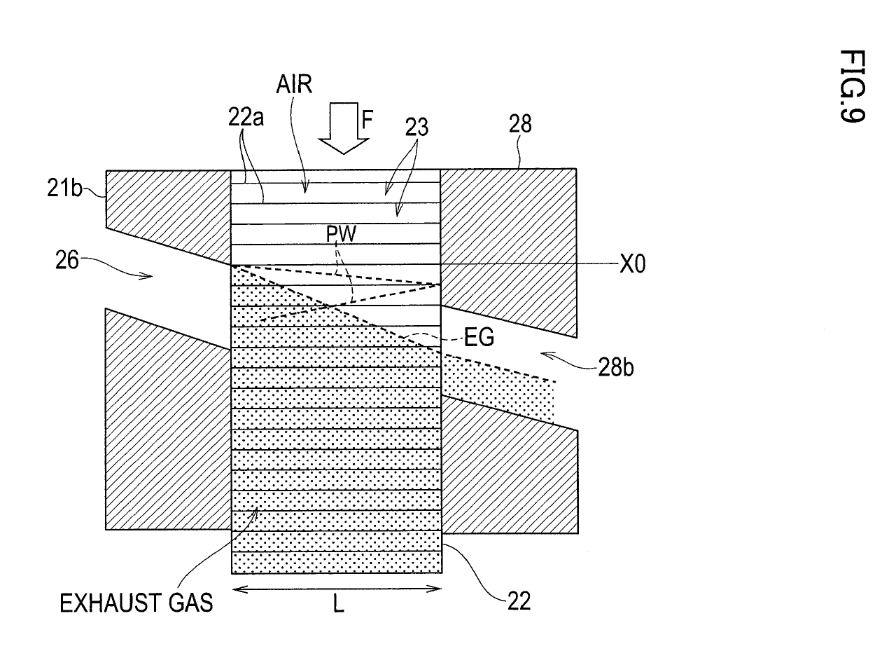

FIG. 9 shows the inside of the pressure wave supercharger 20 developed along the rotation direction of the rotor 22 when the normal mode is changed to a state of decreasing only the rotation speed of the rotor 22. In this figure, the same components as those in FIG. 7 are denoted by the same reference numeral, and descriptions thereof will be omitted. As shown in FIG. 9, the EGR gas is recirculated into the intake gas passage 3 even though only the rotation speed of the rotor 22 is decreased. However, since the position of the valve plate 28 remains unchanged, the pressure wave reaches the intake gas end of the cell 23 before the cell 23 is connected with the intake gas output port 28b. Thereby, insufficiently pressurized gas is discharged to the intake gas passage 3. To solve this problem, in the EGR mode, the position of the valve plate 28 is adjusted so that the cell 23 is connected with the intake gas output port 28b when the pressure wave reaches the intake gas end of the cell 23. Specifically, as shown in FIG. 8, the valve plate 28 is rotated as indicated by the arrow Fv, that is, as much as correction angle Δθ in the direction reverse to the rotation direction of the rotor 22 so that the intake gas outlet port 28b approaches the exhaust gas inlet port 26. It is assumed that a difference between the rotation speed of the rotor 22 in the normal mode and the rotation speed thereof in the EGR mode is Δw. The correction angle Δθ is calculated by the following equation (4).

Δθ=Δw(L/u) (4)

In the EGR mode, the rotor 22 and the valve plate 28 are controlled so as to do the following. The cell 23 is connected with the intake gas outlet port 28b when the pressure wave reaches the intake gas end of the cell 23. The boundary between the exhaust gas and the air reaches the intake gas end of the cell 23 before the cell 23 is disconnected from the intake gas outlet port 28b. Consequently, the pressure wave supercharger 20 performs supercharging while the exhaust gas is recirculated.

Returning to FIG. 6, the description of the control system of the pressure wave supercharger 20 will be continued. The ECU 40 switches between the normal mode and the EGR mode depending on operation states of the engine 1. The ECU 40 controls the first motor 29 and the second motor 30 so that the quantity of exhaust gas (EGR gas) to be recirculated is led into the intake gas passage 3 from the pressure wave supercharger 20 in the EGR mode. As shown in this figure, the ECU 40 includes an EGR rate calculation portion 41, a rotor rotation number calculation portion 42, and a phase angle calculation portion 43. The EGR rate calculation portion 41 calculates a target EGR rate EGRR based on the rotation number of the engine 1 and the accelerator opening. The EGR rate is obtained by dividing the quantity of EGR gas by the quantity of intake air. Thereby, the EGR rate calculation portion 41 corresponds to a target EGR quantity setting device of the present invention. The target EGR rate EGRR may be calculated by a publicly known method obtaining based on the rotation number and the load of the engine 1.

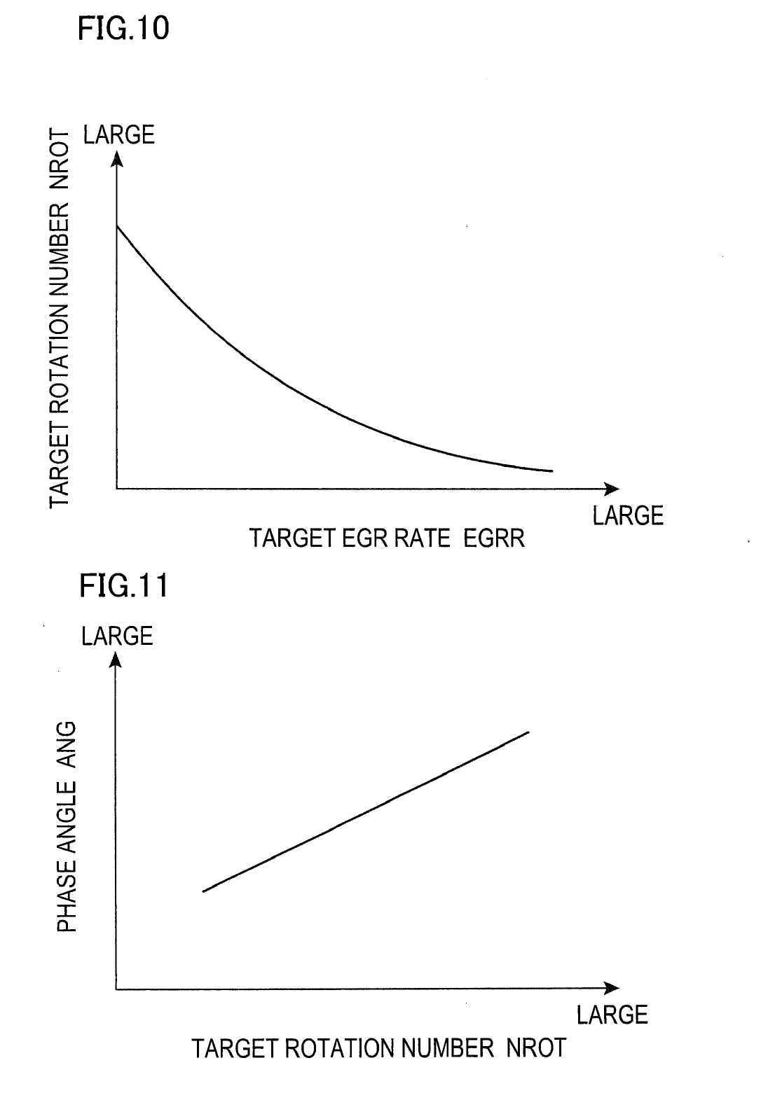

The calculated target EGR rate EGRR is output to the rotor rotation speed calculation portion 42. In the rotor rotation number calculation portion 42, a target rotation number NROT of the rotor 22 is calculated based on the target EGR rate EGRR. As described above, the quantity of EGR gas increases as the rotation number of the rotor 22 is decreases. A relation between the target EGR rate EGRR and the target rotation number NROT shown in FIG. 10 is obtained in advance through experiments or the like and is stored as a map in the ROM of the ECU 40. The rotor rotation number calculation portion 42 may calculate the target rotation number NROT with reference to the map.

The calculated target rotation number NROT is output to the first driver 31 and the phase angle calculation portion 43. The first driver 31 controls the first motor 29 so that the first motor 29 rotates at the target rotation number NROT. The phase angle calculation portion 43 calculates a phase angle ANG (see FIG. 8) based on the target rotation number NROT. The phase angle ANG is formed between the reference position X0 and the open position X1. The phase angle ANG is an angle that the cell 23 connects with the intake gas outlet port 28b when the pressure wave reaches the intake gas end of the cell 23. As is obvious from FIG. 8 and the equation (4), the phase angle ANG needs to be decreased as the rotation number of the rotor 22 decreases. The phase angle ANG may be calculated by using the above-described equation (4), for example. Furthermore, the phase angle ANG may be calculated with reference to a map shown in FIG. 11. FIG. 11 shows a relation between the target rotation number NROT and the phase angle ANG. The relation may be obtained in advance through experiments or the like and may be stored in the ROM of the ECU 40. The calculated phase angle ANG is output to the second driver 32. The second driver 32 controls the second motor 30 so that an angle between the reference position X0 and the open position X1 becomes the phase angle ANG.

As described above, according to the supercharging system of the present invention, since it is possible to change the rotation number of the rotor 22, it is possible to adjust the rotation number of the rotor 22 so that the EGR rate of the engine 1 becomes the target EGR rate. In the supercharging system of the present invention, it is possible to change the position of the intake gas outlet port 28b with reference to the exhaust gas inlet port 26. Thereby, it is possible to adjust the position of the intake gas cutlet port 28b with respect to the exhaust gas inlet port 26 so that the cell 23 is connected with the intake gas outlet port 28b when the pressure wave reaches the intake gas end of the cell 23 even though the rotation number of the rotor 22 is changed. Accordingly, it is possible to recirculate the target quantity of exhaust gas into the intake gas passage 3 via the pressure wave supercharger 20 without decreasing the supercharging pressure.

The present invention is not limited to the above-described embodiments, and may be executed in various modes. For example, the internal combustion engine to which the supercharging system of the present invention is applied is not limited to the diesel engine. The supercharging system of the present invention may be applied to a spark-ignited internal combustion engine that uses a spark plug to ignite air-fuel mixture led into the cylinder. The turbocharger may be provided with a variable nozzle that changes a flow passage area of an inlet of the turbine. The turbocharger may be also provided with a wastegate valve that decreases a quantity of exhaust gas flowing into the turbine. Furthermore, the turbocharger may be omitted.

In the above-described embodiments, the position of the intake gas outlet port with respect to the exhaust gas inlet port is changed by rotating the intake gas outlet port around the axis line. However, the relative position of the intake gas outlet port with respect to the exhaust gas inlet port may be changed by rotating the exhaust gas inlet port instead of the intake gas outlet port around the axis line. In this case, a valve plate may be provided between the exhaust side end of the case and the rotor. Furthermore, the relative position of the intake gas outlet port with respect to the exhaust gas inlet port may be changed by rotating both the intake gas outlet port and the exhaust gas inlet port around the axis line. In this case, valve plates may be provided on both sides of the rotor.

In the above-described embodiments, the rotor is rotated by the electric motor. However, the rotor may be rotated using a rotation of a crankshaft of the internal combustion engine. In this case, a variable speed mechanism such as a continuously variable transmission may be provided in a power transmission path from the crankshaft to the rotor, and the rotation number of the rotor may be changed by the variable speed mechanism. In this case, the variable speed mechanism corresponds to the rotation number change device of the present invention.

1. A supercharging system for an internal combustion engine comprising:
a pressure wave supercharger that includes a rotor which is arranged in a case rotatably around an axis line, plural cells which are provided in the case so as to penetrate from one end to the other end in a direction of the axis line of the case and rotate with the rotor, an intake gas outlet portion which is provided on the one end of the case and is connected with an intake gas passage of an internal combustion engine, an intake gas inlet portion which is provided on the one end of the case, an exhaust gas inlet portion which is provided on the other end of the case and is connected with an exhaust gas passage of the internal combustion engine, and an exhaust gas outlet portion which is provided on the other end of the case, and
that performs supercharging of the internal combustion engine by increasing a pressure of gas in each of the cells using a pressure wave of exhaust gas led into the cell from the exhaust gas inlet portion and discharging from the intake gas outlet portion to the intake gas passage the gas pressurized, wherein the supercharging system comprises:
a rotation number change device capable of changing the rotation number of the rotor,
a phase change mechanism capable of changing a position of the intake gas outlet portion with respect to the exhaust gas inlet portion by rotating at least either one of the exhaust gas inlet portion and the intake gas outlet portion around the axis line,
a target EGR quantity setting device which sets a target EGR quantity as a quantity of flow of exhaust gas to be recirculated from the exhaust gas passage to the intake gas passage based on an operation state of the internal combustion engine,
a control device which controls based on the target EGR quantity the rotation number change device and the phase change mechanism so as to change the rotation number of the rotor and the position of the intake gas outlet portion with respect to the exhaust gas inlet portion respectively, wherein
the control device controls the rotation number change device and the phase change mechanism so that the rotation number of the rotor decreases while the intake gas outlet portion approaches the exhaust gas inlet portion, as the target EGR quantity increases.

2. (canceled)

3. The supercharging system according to claim 1, wherein
the control device controls the rotation number change device and the phase change mechanism so that the pressure wave of the exhaust gas led into the cell from the exhaust gas inlet portion reaches an intake gas outlet portion side end of the cell when the rotor rotates and the cell connects with the intake gas outlet portion.

4. The supercharging system according to claim 1, wherein
an electric motor which rotates the rotor is provided as the rotation number change device.
